(19) United States
(12) Patent Application Publication
(10) Pub. No.: US 2013/0119777 A1
(43) Pub. Date: May 16, 2013

(54) WIRELESS ENERGY TRANSFER SYSTEMS

(71) Applicant: Shaw Industries Group, Dalton, GA (US)

(72) Inventor: John J.M. Rees, Chattanooga, TN (US)

(73) Assignee: SHAW INDUSTRIES GROUP, Dalton, GA (US)

(21) Appl. No.: 13/669,076

(22) Filed: Nov. 5, 2012

Related U.S. Application Data
(60) Provisional application No. 61/555,219, filed on Nov. 3, 2011.

(51) Int. Cl. H01F 38/14

(52) U.S. Cl. CPC H01F 38/14
USPC 307/104

(57) ABSTRACT

An inductively coupled power system for use in a structure having at least one power emitter electrically coupled to an external electrical power source and at least one power receptor directly coupled to a load with direct electrical connections, which is configured to inductively couple to energy wirelessly resonating from the at least one power emitter and to convert the inductively received energy to a desired output energy configuration for supply to the load. The system can also include at least one passive power emitter that is configured to be inductively coupled to energy wirelessly resonating from the at least one power emitter or the at least one passive power emitter.

### CROSS-REFERENCE TO RELATED APPLICATION

This application claims the benefit of priority to U.S. Provisional Patent Application Ser. No. 61/555,219, filed on Nov. 3, 2011, the entire disclosure of which is incorporated by reference herein for all purposes.

### FIELD OF THE INVENTION

This invention relates generally to wireless energy transfer, or wireless power transmission, within a structure.

### BACKGROUND OF THE INVENTION

Conventional electronic devices so common in today's world problematically require associated cords and cables for charging and/or operating the electronic devices. In an effort to minimize the issues of limited sources to directly connect to a structures electrical grid, technology has been developed to address these limitations by providing an inductively coupled power circuit. This known non-radiative, or near-field, wireless energy transfer scheme, often referred to as either induction or traditional induction, does not (intentionally) radiate power, but uses an oscillating current passing through a primary coil, to generate an oscillating magnetic near-field that induces currents in a near-by receiving or secondary coil. Conventional induction schemes have demonstrated the transmission of modest to large amounts of power, however only over very short distances, and with very small offset tolerances between the primary power supply unit and the secondary receiver unit. Electric transformers and proximity chargers are examples of devices that utilize this known short range, near-field energy transfer scheme. As one will appreciate and depending on the select devices being employed in respective portions of the structure this power transfer can occur under multiple, varying load conditions.

A substantial demand exists however for a wireless power transfer scheme that is capable of readily supplying the power needs of users within the structure and that can be unobtrusively provided within select portions of the underlying assembly of the structure.

### SUMMARY

This invention addresses the above-described problems by providing a system and method for wireless energy transfer system that minimizes any requirement for exposed outlets directly coupled to the electrical grid of a building structure. There is disclosed herein a non-radiative or near-field wireless energy transfer scheme that is capable of transmitting useful amounts of power within interior volumes defined within a building structure. In one aspect, the inductively coupled power system described herein can comprise at least one power emitter electrically coupled to an external electrical power source and at least one power receptor directly coupled to a load with direct electrical connections. The at least one power emitter can be mountable at a select or desired location within the building structure. In one aspect, the at least one power receptor can be configured to inductively couple to energy wirelessly resonating from the at least one power emitter and to convert the inductively received energy to a desired output energy configuration for supply to the load. It is contemplated that the power receptor can be selectively mountable therein the building structure.

As a result, the disclosed system can have a wide variety of possible applications where the at least one power emitter, connected to a power source, is in one or more locations, and the at least one power receptor, potentially connected to electrical/electronic devices, batteries, powering or charging circuits, and the like, is at a spaced location, and where the distance from the at least one power emitter to the at least one power receptor is on the order of inches to feet. For example, the at least one power emitter connected to the wired electricity grid could be placed on a surface of the ceiling, wall, or floor, of a room as desired, while other power receptors distributed throughout the room can be connected to electrically powered devices, such as computers, communication devices, and the like, and where these electrically powered devices are constantly or intermittently receiving power wirelessly from the power emitters and/or passive power emitters. From this one example, it is contemplated that many applications where the systems and methods disclosed herein could provide wireless power within rooms of a building structure, including consumer electronics, industrial applications, infrastructure power and lighting, electronic games, and the like.

This disclosure describes wireless energy transfer technologies, also referred to as wireless power transmission technologies. As one will appreciate, the terms wireless energy transfer, wireless power transfer, wireless power transmission, and the like, can be used interchangeably. It is also contemplated that supplying energy or power from a source, such as an AC or DC source, a battery, a source resonator, a power supply, a generator, a solar panel, and thermal collector, and the like, to a electrically powered device, a remote electrically powered device, to multiple remote electrically powered devices, to the at least one power emitter, and the like.

It is contemplated that the power receptor can receive energy from a power emitter and can convert a portion of that energy to electric power for powering or charging an electrically powered device. In a further aspect, it is also contemplated that the system and method disclosed herein can comprise at least one passive power emitter mountable at a select locations within the building structure that is configured to be inductively coupled to energy wirelessly resonating from the at least one power emitter and/or the at least one passive power emitter. Thus, in this aspect, the passive power emitter is configured to act as a wireless energy emitter and receiver simultaneously. Thus, in various aspects, energy can be wirelessly transferred from a power emitter to one or more passive power emitters and/or one of more power receptors, which significantly increases the operable availability of conventional electrical power for users within the room of the structure.

### DESCRIPTION OF THE DRAWINGS

The accompanying drawings, which are incorporated in and constitute a part of this specification, illustrate certain aspects of the instant invention and together with the description, serve to explain, without limitation, the principles of the invention. Like reference characters used therein indicate like parts throughout the several drawings.

FIG. 1 is schematic view of the wireless energy transfer system comprising at least one power emitter coupled to an external power source; at least one power receptor; and an optional at least one passive power emitter configured to allow for the wireless transfer of energy between the components of the system.

FIGS. 2 and 3 are exemplary views of an embodiment of a power emitter that is configured to be mounted to the underlayment of a floor of a building structure.

FIGS. 4 and 5 are exemplary views of an embodiment of a power receptor suitable for being positioned on a desired surface of the building structure such on the surface of the floor of the building structure.

FIGS. 6 and 7 are exemplary views of an embodiment of a power receptor suitable for being positioned on a bottom surface of a table.

FIGS. 8 and 9 are exemplary views of an embodiment of a passive power emitter formed in a carpet tile. FIG. 8 shows an exploded view and FIG. 9 shows a partial cross sectional view of the exemplary power emitter.

FIGS. 10 and 11 are exemplary views of an embodiment of a corded coil coupling.

### DETAILED DESCRIPTION OF THE INVENTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used herein, the singular forms “a,” “an” and “the” include plural referents unless the context clearly dictates otherwise. Thus, for example, reference to a “power emitter” includes aspects having two or more such power emitters unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance can or can not occur, and that the description includes instances where said event or circumstance occurs and instances where it does not.

Referring to the figures, exemplary embodiments of a wireless power transfer system are illustrated. In one aspect, it is contemplated that one or more portions of the wireless power transfer system can be disposed beneath or formed integrally with a carpet for use as flooring in the building structure. As used herein, the term “carpet” is used in its conventional sense to mean a carpet that extends over a predetermined floor area, such as, for example, a floor area extending between one vertical wall or vertical structure to the opposing vertical wall or vertical structure. As used herein, and unless the context clearly indicates otherwise, the term carpet is used to generically include broadloom carpet, carpet tiles, and even area rugs. To that “broadloom carpet” means a broadloom textile flooring product manufactured for and intended to be used in roll form. “Carpet tile” denotes a modular floor covering, conventionally in 18″×18,″ 24″×24″ or 36″×36″ squares, but other sizes and shapes are also within the scope of the present invention. The term carpet is also used in its conventional sense to mean a carpet that is, for example and without limitation, either tufted or woven.

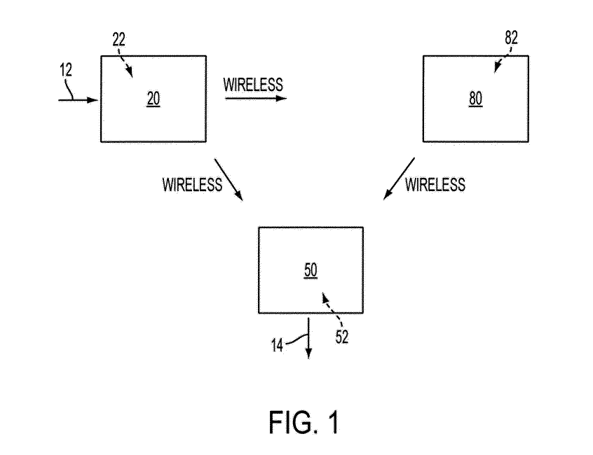

Disclosed herein is a non-radiative or near-field wireless energy transfer scheme that is capable of transmitting useful amounts of power within interior volumes defined within a building structure. Referring to FIG. 1, in one aspect, the inductively coupled power system 10 described herein can comprise at least one power emitter 20 electrically coupled to an external electrical power source 12 and at least one power receptor 50 directly coupled to a load 14 with direct electrical connections. In one aspect, the at least one power emitter 20 can comprise at least one primary coil 22 of at least one turn of a conducting material. In this aspect, the at least one primary coil 22 of the least one power emitter is electrically coupled to the external electrical power source 12. In one exemplary aspect, the at least one primary coil 22 can comprise a plurality of primary coils selected from the group consisting of a low power primary coil, a medium power primary coil, and a high power primary coil, or combinations thereof. In another aspect, it is contemplated that the at least one power emitter 20 can be mountable at select or desired locations within the building structure.

In another aspect, the at least one power receptor 50 can be configured to inductively couple to energy wirelessly resonating from the at least one power emitter 20 and to convert the inductively received energy to a desired output energy configuration for supply to the load 14. In one aspect, the at least one power receptor can comprise at least one secondary coil 52 of at least one turn of a conducting material that is configured to inductively couple to energy wirelessly resonating from the at least one power emitter and to convert the inductively received energy to a desired output energy configuration for supply to the load. In one exemplary aspect, the at least one secondary coil 52 can comprise a plurality of primary coils selected from the group consisting of a low power primary coil, a medium power primary coil, and a high power primary coil, or combinations thereof. In this aspect, it is contemplated that the power receptor can be selectively mountable therein the building structure.

Optionally, the system can further comprise at least one passive power emitter 80 mountable at select locations within the building structure. In one aspect the at least one passive power emitter 80 can comprise at least one coil 82 of at least one turn of a conducting material that is configured to be inductively coupled to energy wirelessly resonating from the at least one power emitter or the at least one passive power emitter. Of course, it is contemplated that the at least one passive power emitter can comprise a plurality of coils which can exemplarily comprise a low power primary coil, a medium power primary coil, and a high power primary coil, or combinations thereof.

In one aspect, the at least one passive power emitter can comprise a plurality of passive power emitters. In this scheme, each passive power emitter can be configured to wirelessly receive and transmit energy. In another aspect, each passive power emitter can be configured to be inductively coupled to at least one other passive power emitter or at least one power receptor. In a further aspect, and as described in more detail below, the at least one passive power emitter is positioned therein a portion of a carpet structure, for example and without limitation, as a portion of the structure of a carpet tile.

It is also contemplated that the system could comprise visible identification indicators on the respective surfaces of the structure to indicate the relative position of one or more of the at least one power emitter, the at least one power receptor, and/or the at least one passive power emitter.

Thus, the disclosed system can have a wide variety of possible applications where the at least one power emitter, connected to a power source, is in one or more locations, and the at least one power receptor, potentially connected to electrical/electronic devices, batteries, powering or charging circuits, and the like, is at a spaced location, and where the distance from the at least one power emitter to the at least one power receptor is on the order of inches to feet. For example, the at least one power emitter connected to the wired electricity grid could be placed on a surface of the ceiling, wall, or floor, of a room as desired, while other power receptors distributed throughout the room can be connected to electrically powered devices, such as computers, communication devices, and the like, and where these electrically powered devices can be configured to constantly or intermittently receive power wirelessly. From this one example, it is contemplated that many applications where the systems and methods disclosed herein could provide wireless power within rooms of a building structure, including consumer electronics, industrial applications, infrastructure power and lighting, electronic games, and the like.

This disclosure describes wireless energy transfer technologies, also referred to as wireless power transmission technologies. As one will appreciate, the terms wireless energy transfer, wireless power transfer, wireless power transmission, and the like, can be used interchangeably. It is also contemplated that supplying energy or power from a source, such as an AC or DC source, a battery, a source resonator, a power supply, a generator, a solar panel, and thermal collector, and the like, to a electrically powered device, a remote electrically powered device, to multiple remote electrically powered devices, to the at least one power emitter, and the like. It is therefore contemplated that the power receptor can be configured to be coupled to: a power conversion circuit configured to deliver DC power to the load; a power conversion circuit configured to deliver AC power to the load; a power conversion circuit configured to deliver both AC and DC power to the load; and/or a power conversion circuit configured to deliver power to a plurality of loads.

In various optionally aspects, it is contemplated that the at least one power emitter can be mountable to a bottom surface of a floor assembly of the structure, to a undersurface of a wall assembly of the structure, or any other desired surface or within a respective assembly of the building structure. It is also contemplate, in various non-limiting embodiments, that the at least one power receptor can be mountable underneath a carpet positioned on the floor of the structure or to a portion of underneath a furniture assembly positioned therein the interior of the structure. In the latter aspect, the at least one secondary coil of at least one power receptor can be embedded in a work surface of the furniture assembly.

As one skilled in the art will therefore appreciate, it is contemplated that the power receptor can wirelessly receive energy from a power emitter and can convert a portion of that energy to electric power for powering or charging an electrically powered device. Optionally, the passive power emitter can be configured to act as a wireless energy emitter and receiver simultaneously. Thus, in various aspects, energy can be wirelessly transferred from a power emitter to one or more passive power emitters and/or one of more power receptors, which significantly increases the operable availability of conventional electrical power for users within the room of the structure.

### Power Emitter

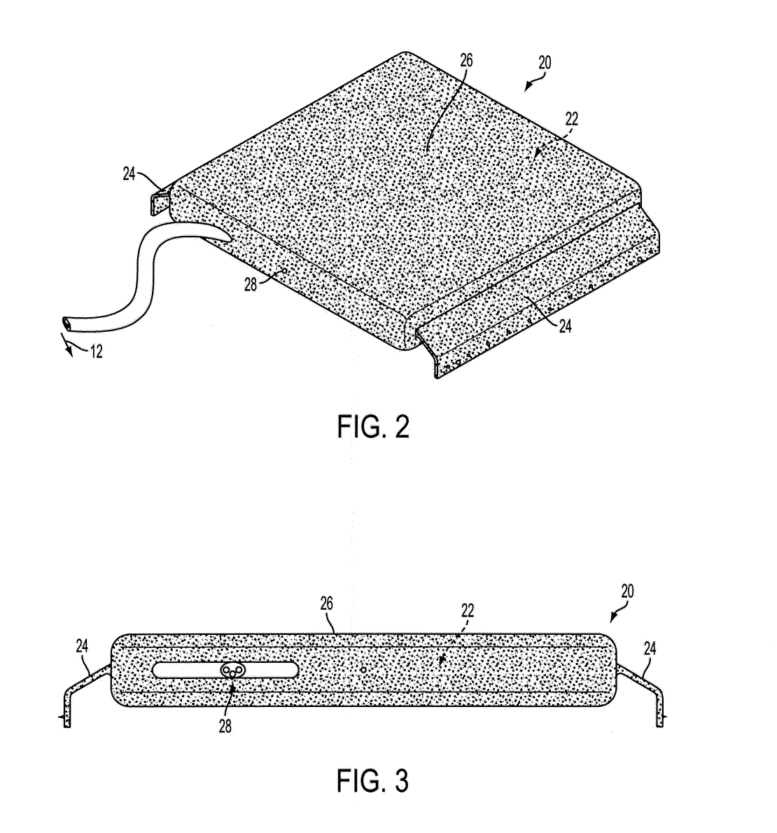

Referring now to FIGS. 2 and 3, an exemplary embodiment of a power emitter 20 is shown. In this embodiment, the at least one primary coil 22 that comprises at least one turn of a conducting material can be formed from a centered copper wire or printed copper ink pattern in a coil configuration. It is contemplated that the at least one primary coil can be encapsulated or otherwise embedded in thermoplastic to protect the coil from potentially damaging external environmental effects and is housed within a thermoplastic enclosure, which can use PEM or “nut-sert” threaded nuts and matching machine screws to secure one clam shell module half to another to form the enclosure.

In another aspect, a printed control circuit board in communication with the at least one primary coil 22 can be enclosed within the enclosure 26. In one aspect, the circuit board can be used for converting a directly coupled source of electrical power, such as, for example, conventional 110 volt AC power, to the highly resonate strong coupling electrical signals generated by the at least one primary coil so that, in operation, AC power can be wirelessly beamed from the power emitter, which can be positioned as desired, in this example under subfloor-located, to one or more passive power emitters or to one or more power receptors.

As exemplarily shown, to assist in mounting the enclosure of the power emitter to the select location within the building structure, a pair of opposed wing members 24 can be coupled to and extend therefrom opposite sides of the enclosure. As one skilled in the art will appreciate, the respective ends of the wing members can be positioned at a desired distance apart for conforming fit between portions of the building structure. In one example, the wing members 24 can be configured to be spaced approximately 16 inches apart for mounting to 16 inch conventionally spaced 16 inch floor joist. In various optional aspects, each wing member can have at least at least one mounting hole defined therein that is configured to accept a conventional fastener, such as a nail or screw, to fix the power emitter is the desired location, such as a floor joist, and/or can have at least one male protrusion point or pin extending outwardly from the end portion of the wing member, which are suitably configured to be operationally indented into the surface of the joist to secure the enclosure of the power emitter in the desired location. Nails or screws can further secure the housing between the joists by using the mounting holes. Optionally, the wing members can be configured to flex to accommodate a friction fit mounting of the enclosure of the power emitter.

The power emitter can further comprise a dual-color LED indicator 28 that is mounted therein the surface of the enclosure. In various aspects, it is contemplated that a “green” LED indicates that sufficient electrical amperage is available to power the plugged in load. If insufficient power is available to support the connected amperage, then the LED turns to red and power to the circuitry is dynamically shut off, before overheating the system.

### Power Receptor

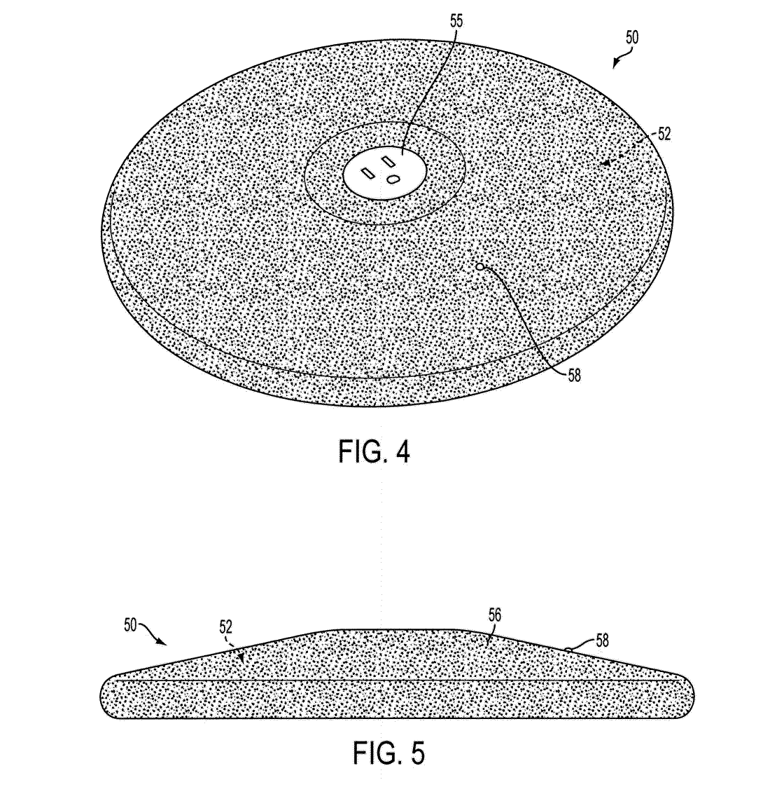

Referring now to FIGS. 4-7, an exemplary embodiment of a power receptor 50 is shown. In this embodiment, the at least one secondary coil 52 that comprises at least one turn of a conducting material can be formed from a centered copper wire or printed copper ink pattern in a coil configuration. The at least one secondary coil can be encapsulated between two opposing thermoplastic to protect the coil from potentially adverse external environmental effects. In one aspect, the at least one secondary coil and a printed control circuit board are enclosed therein an enclosure 56, such as the exemplary discus-shaped enclosure shown in FIGS. 2-3, which can be formed from a suitable polymeric material. In one aspect, PEM or “nut-sert” threaded nuts and matching machine screws can be used to selectively secure one clam shell module half to the other to form the enclosure of the power receptor.

In one aspect, the printed circuit board can be configured to convert the received highly resonate strong coupling electrical signals to a desired conventional power, such as 110 volt AC power. At least one, and preferably a plurality of outlets 55, such as AC outlets, can be positioned on an exterior portion of the enclosure of the power receptor. These outlets are operatively coupled to the printed circuit board and are configured to receive the generated and converted power. It is contemplated that the outlets can have a conventional shape for ready acceptance of power cords of conventional electrical devices.

In a further aspect, it is contemplated that each outlet of the power receptor can comprise a multi-color LED 58. In various aspects, it is contemplated that a “green” LED indicates that sufficient electrical amperage is available to power the plugged in load for that particular outlet. If insufficient power is available to support the connected amperage at the particular outlet, then the LED turns to red and power to the circuitry is dynamically shut off, before overheating the system. Further, a yellow LED indicates a marginal attached load, which indicates that the coupled electrical device should be disconnected from the outlet of the power receptor.

As one will appreciate, in operation, wireless energy from one or both of an exemplary passive power emitter or a power emitter, is received by the secondary coil of the power receptor and is converted to available AC Power by the highly resonate strong coupling circuitry.

As exemplarily shown, without limitation, FIGS. 4 and 5 are exemplary views of an embodiment of a power receptor suitable for being positioned on a desired surface of the building structure such on the surface of the floor of the building structure.

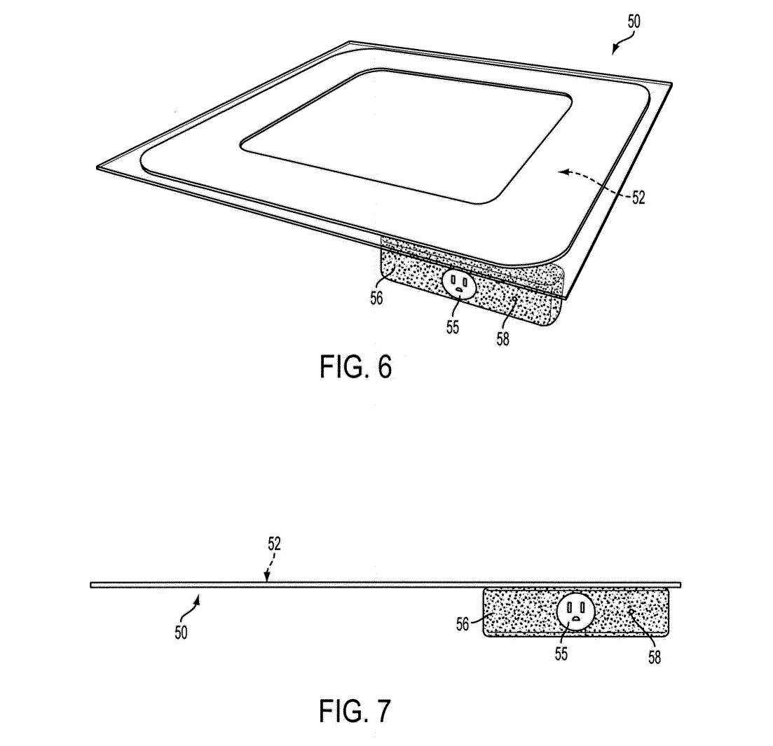

With respect to the exemplary power receptor shown in FIGS. 6 and 7, the at least one secondary coil 52 can be formed from a centered copper wire or printed copper ink pattern in a coil configuration that can be encapsulated between two opposing thermoplastic to protect the coil from potentially adverse external environmental effects. In this exemplary aspect, the formed laminated single sheet is then coupled to an AC power module that can be suitably and conventionally selectively mounted, such as with pressure sensitive adhesive, screws, Velcro, and the like, to a underside surface of a piece of furniture, such as the exemplified and illustrated table. As shown, it is contemplated that the AC power module 56, which houses the printed circuit board configured to convert the received highly resonate strong coupling electrical signals to a desired conventional power, such as 110 volt AC power, can have one or more power outlets 55, such as AC power outlets that are operatively coupled to the printed circuit board and are configured to receive the generated and converted power. It is contemplated that the outlets can have a conventional shape for ready acceptance of power cords of conventional electrical devices.

In a further aspect, it is contemplated that each outlet of the power receptor can comprise a multi-color LED 58. In various aspects, it is contemplated that a “green” LED indicates that sufficient electrical amperage is available to power the plugged in load for that particular outlet. If insufficient power is available to support the connected amperage at the particular outlet, then the LED turns to red and power to the circuitry is dynamically shut off, before overheating the system. Further, a yellow LED indicates a marginal attached load, which indicates that the coupled electrical device should be disconnected from the outlet of the power receptor.

### Passive Power Emitter

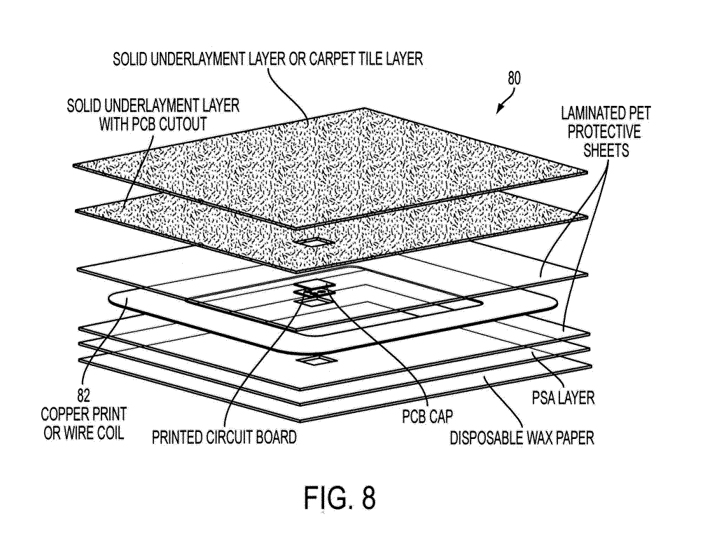

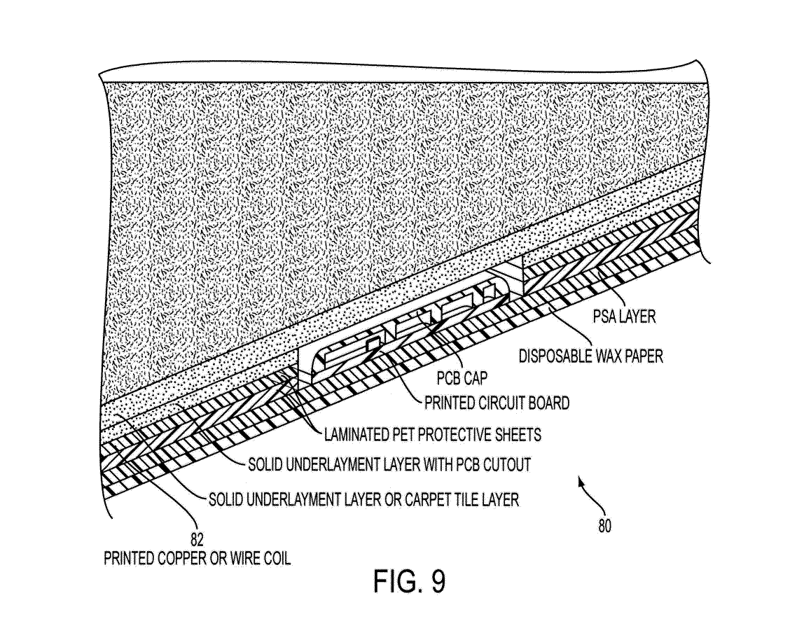

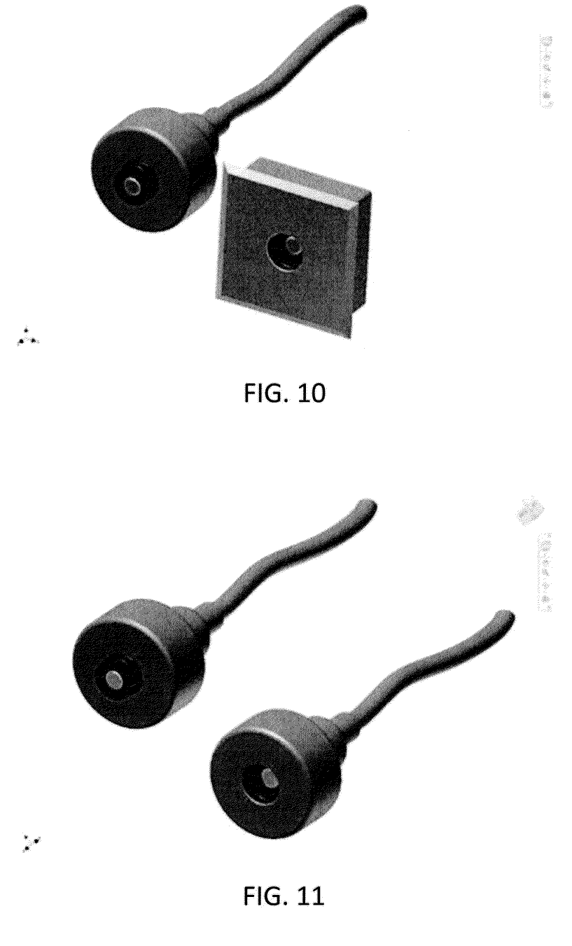

Referring now to FIGS. 8 and 9, an exemplary embodiment of a passive power emitter 80 is shown that is integrated therein a carpet tile. In this embodiment, the at least one coil 82 that comprises at least one turn of a conducting material can be formed from a centered copper wire or printed copper ink pattern in a coil configuration. The at least one coil can be laminated or otherwise encapsulated between two opposing thermoplastic to protect the coil from potentially adverse external environmental effects.

In another aspect, a printed control circuit board other conventional electronic components, such as at least one tuning capacitor can be configured in operative communication with the at least one coil and can be enclosed and protected by a non-conductive epoxy potting compound, by an injection molded polymeric cap, and the like. In another aspect, it is contemplated that the electronic components and coil can be further protected by the cushioning effect of the underlayment substrate that the carpet tile is selectively mounted on to or embedded into.

In this aspect, the passive power emitter forms a carpet cushion in a carpet tile form in which the coil is operably connected to matched and tuned highly resonate strong coupling circuitry, i.e, the coil 82 of the passive power emitter is configured to be inductively coupled to energy wirelessly resonating from a spaced at least one power emitter and/or another separate and spaced at least one passive power emitter. In this scheme, each carpet tile passive power emitter can be configured to wirelessly receive and transmit energy and/or can be configured to be inductively coupled to at least one other passive power emitter or at least one power receptor.

It is contemplated that each passive power emitter carpet tile can be installed, much like installing conventional carpet tile, using an installer applied glue or peel and stick pressure sensitive adhesive. The tiles can be arrayed over the entire floor in the room or strategically located where wireless access to power is desired. As one will appreciate, it is contemplated that a desired array of power emitters and passive power emitters can be strategically located in a room to ensure maximal or desired access to electrical power.

### Corded Coupling

In one embodiment, the corded coil coupling is configured to provide power remotely from a hot zone outlet or a female corded umbilical to a connection cord, without the use of electrical contacts. The coupling is hermetically sealed, which allows for the corded coil coupling to be impervious to moisture. The corded coil coupling comprises an outlet that is magnetically coupled to an extension cord. In various aspects, it is contemplated that the female coil outlet can be mounted to an exterior wall with seals, screws, clamping, and the like to create a secure and weather resistant connection point. In one aspect, a male coil plug has detents that are configured to hold the mail coil plug in place using the complementarily matched female socket as an anchor point. Once in place, the coils within the male plug can transmit a magnetic field for conversion to electricity. In another aspect, means for selectively coupling the male plug to the female outlet can comprise a spring loaded detent, elastomeric O-Rings, interference fit, elastomeric snap fit, magnets, and the like

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is therefore understood that the invention is not limited to the specific embodiments disclosed herein, and that many modifications and other embodiments of the invention are intended to be included within the scope of the invention. Moreover, although specific terms are employed herein, they are used only in a generic and descriptive sense, and not for the purposes of limiting the described invention.

What is claimed is:

1. An inductively coupled power system for use in a structure, comprising:
at least one power emitter comprising at least one primary coil of at least one turn of a conducting material, wherein the at least one primary coil of the least one power emitter is electrically coupled to an external electrical power source, and wherein the least one power emitter is mountable at a select location within the structure;
at least one power receptor directly coupled to a load with direct electrical connections, the at least one power receptor comprising at least one secondary coil of at least one turn of a conducting material that is configured to inductively couple to energy wirelessly resonating from the at least one power emitter and to convert the inductively received energy to a desired output energy configuration for supply to the load, wherein the power receptor is selectively mountable therein the structure.

2. The system of claim 1, further comprising indicators on the surface of the structure that indicate the location of the at least one power emitter.

3. The system of claim 1, wherein the at least one primary coil comprises a plurality of primary coils selected from the group consisting of a low power primary coil, a medium power primary coil, and a high power primary coil.

4. The system of claim 1, wherein the power receptor is coupled to a power conversion circuit to deliver DC power to the load.

5. The system of claim 1, wherein the power receptor is coupled to a power conversion circuit to deliver AC power to the load.

6. The system of claim 1, wherein the power receptor is coupled to a power conversion circuit to deliver both AC and DC power to the load.

7. The system of claim 1, wherein the power receptor is coupled to a power conversion circuit to deliver power to a plurality of loads.

8. The system of claim 1, further comprising at least one passive power emitter comprising at least one coil of at least one turn of a conducting material, wherein the at least one coil of the passive power emitter is configured to be inductively coupled to energy wirelessly resonating from the at least one power emitter or the at least one passive power emitter, wherein each at least one passive power emitter is mountable at a select location within the structure.

9. The system of claim 8, wherein the at least one passive power emitter comprising a plurality of passive power emitters, wherein each passive power emitter is configured to wirelessly receive and transmit energy.

10. The system of claim 9, wherein the at least one passive power emitter is inductively coupled to at least one other passive power emitter or at least one power receptor.

11. The system of claim 8, wherein the at least one passive power emitter is positioned therein a carpet structure.

12. The system of claim 11, wherein the carpet structure is a carpet tile.

13. The system of claim 1, wherein the at least one power emitter is mountable to a bottom surface of a floor assembly of the structure.

14. The system of claim 1, wherein the at least one power emitter is mountable to an undersurface of a wall assembly of the structure.

15. The system of claim 1, wherein the at least one power receptor is mountable underneath a carpet assembly positioned on the floor of the structure.

16. The system of claim 1, wherein the at least one power receptor is mountable to a portion of underneath a furniture assembly positioned therein the interior of the structure.

17. The system of claim 6, wherein the at least one secondary coil of at least one power receptor is embedded in a work surface of the furniture assembly.
